(19) United States
(12) Patent Application Publication
(10) Pub. No.: US 2018/0053610 A1
(43) Pub. Date: Feb. 22, 2018

(54) LUMNIOUS KEYBOARD

(71) Applicant: PRIMAX ELECTRONICS LTD., Taipei (TW)

(72) Inventors: Chun-Yuan Liu, Taipei (TW); Tsu-Yi Chen, Taipei (TW)

(21) Appl. No.: 15/337,805

(22) Filed: Oct. 28, 2016

(30) Foreign Application Priority Data
Aug. 19, 2016 (TW) 105126573

(51) Int. Cl. H01H 13/83; G06F 3/02; F21V 33/00; F21V 8/00; H01H 13/702; H01H 13/7065

(52) U.S. Cl. CPC H01H 13/83; G06F 3/0202; F21V 33/0052; H01H 13/7065; G02B 6/0038; G02B 6/0053; H01H 13/702; G02B 6/005

(57) ABSTRACT

A luminous keyboard includes plural key structures and a light guide plate. Moreover, plural elongated condenser structures are formed on a top surface of the light guide plate. Each of the plural elongated condenser structures has a long axial direction. The plural elongated condenser structures are distributed in parallel and along a direction perpendicular to the long axial direction. After plural light beams pass through the elongated condenser structures in the upward direction, the beam angles of the light beams from the light guide plate are converged by the elongated condenser structures. Consequently, the brightness of the backlight is increased. Moreover, the light beams do not leak from the vacant spaces between adjacent key structures.

### FIELD OF THE INVENTION

The present invention relates to a luminous keyboard, and more particularly to a luminous keyboard capable of avoiding light leakage from rims of key structures.

### BACKGROUND OF THE INVENTION

As known, keyboards are indispensable input devices for people in the modern societies. Generally, plural keys are installed on a top surface of the keyboard. Via the keyboard, the user can press one or more keys to input a command.

With increasing development of keyboards, a keyboard with a backlight module has been prevailing in the market. The keyboard with the backlight module is also referred as a luminous keyboard. When the luminous keyboard is used in an indoor lighting environment such as an office or a room, the human eyes can obviously recognize that the light beams from a bottom side of the luminous keyboard illuminate all keys of the luminous keyboard. Consequently, a visual effect is generated.

However, the conventional luminous keyboard still has some drawbacks. For example, the light beams are not only transmissible through the light-transmissible zones of all keys but also leaked from the vacant spaces between adjacent keys. The portions of the light beams leaked from the vacant spaces between adjacent keys are stray light that interferes with the vision line of the user. The stray light is undesired.

Therefore, the conventional luminous keyboard needs to be further improved.

### SUMMARY OF THE INVENTION

The present invention provides a luminous keyboard. The luminous keyboard includes a light guide plate, and plural elongated condenser structures are formed on a top surface of the light guide plate. By the elongated condenser structures, the beam angles of the light beams from the light guide plate are converged and the light beams are concentrated. Consequently, the light beams do not leak from the vacant spaces between adjacent key structures.

In accordance with an aspect of the present invention, there is provided a luminous keyboard. The luminous keyboard includes plural key structures, a light guide module and a shielding plate. Each of the plural key structures includes a keycap, a movable triggering mechanism, a membrane circuit board and a supporting plate. The movable triggering mechanism is disposed under the keycap and connected with the keycap. The membrane circuit board is disposed under the movable triggering mechanism. The membrane circuit board is triggered by the movable triggering mechanism when the movable triggering mechanism receives an external pressing force from the keycap. The supporting plate is disposed under the membrane circuit board. The movable triggering mechanism is penetrated through the membrane circuit board and movably coupled with the supporting plate. The light guide module is disposed under the supporting plate, and includes a light source and a light guide plate. Moreover, plural elongated condenser structures are formed on a top surface of the light guide plate. The light source emits plural light beams into the light guide plate. The plural light beams travel within the light guide plate and pass through the plural elongated condenser structures. Each of the plural elongated condenser structures has a long axial direction. The plural elongated condenser structures are distributed in parallel and along a direction perpendicular to the long axial direction. The shielding plate is arranged between the supporting plate and the light guide plate. The shielding plate includes plural openings, and the plural openings are aligned with the corresponding keycaps. A vacant space between every two adjacent key structures is sheltered by the shielding plate. After the light beams pass through the elongated condenser structures, beam angles of the light beams are converged. Moreover, first portions of the light beams are reflected back to the light guide plate by the shielding plate, and the first portions of the light beams travel to the plural keycaps through the plural openings. Moreover, second portions of the light beams are not reflected by the shielding plate, and the second portions of the light beams travel to the plural keycaps through the plural openings. The top surface of the light guide plate is a smooth surface.

In an embodiment, the elongated condenser structures are V-cut structures. The V-cut structures are formed on the top surface of the light guide plate and arranged in parallel with each other.

In an embodiment, movable triggering mechanism includes a scissors-type connecting element and a rubbery elastomer. The scissors-type connecting element has a first end and a second end opposed to the first end. The first end of the scissors-type connecting element is connected with the keycap. The second end of the scissors-type connecting element is penetrated through plural through-holes of the membrane circuit board and connected with the supporting plate. The movable triggering mechanism has an accommodation space. The rubbery elastomer is disposed within the accommodation space. An end of the rubbery elastomer is contacted with the membrane circuit board.

In an embodiment, the supporting plate includes plural perforations, and at least portions of the perforations are aligned with the corresponding through-holes. After the second portions of the light beams leave the elongated condenser structures, the second portions of the light beams pass through the openings of the shielding plate, the perforations of the supporting plate and the through-holes of the membrane circuit board sequentially and travel to the keycaps of the plural key structures.

In an embodiment, the light guide plate includes a light guide substrate and a brightness enhancement film. The brightness enhancement film is stacked over the light guide substrate. The plural elongated condenser structures are formed on the brightness enhancement film.

In an embodiment, the light guide plate includes a light guide substrate, a first brightness enhancement film and a second brightness enhancement film. The first brightness enhancement film and the second brightness enhancement film are stacked over the light guide substrate. The elongated condenser structures include plural first elongated condenser structures and plural second elongated condenser structures. The plural first elongated condenser structures are formed on a top surface of the first brightness enhancement film. The plural second elongated condenser structures are formed on the second brightness enhancement film.

In an embodiment, the plural first elongated condenser structures on the first brightness enhancement film are arranged along a first direction and in parallel with each other, and the plural second elongated condenser structures on the second brightness enhancement film are arranged along a second direction and in parallel with each other. The first direction is in parallel with the second direction, or the first direction and the second direction intersect each other.

In an embodiment, the luminous keyboard further includes a fame body. The plural key structures are exposed through the frame body. The light guide module is sheltered by the frame body.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the appearance of a luminous keyboard according to an embodiment of the present invention;

FIG. 2 is a schematic perspective view illustrating a single key structure of the luminous keyboard according to the embodiment of the present invention;

FIG. 3 is a schematic exploded view illustrating the single key structure of the luminous keyboard according to the embodiment of the present invention;

FIG. 4 is a schematic cross-sectional view illustrating the single key structure of the luminous keyboard according to the embodiment of the present invention;

FIG. 5 is an enlarged fragmentary perspective view illustrating the light guide plate of the luminous keyboard according to the embodiment of the present invention;

FIG. 6 is an enlarged fragmentary perspective view illustrating a variant example of the light guide plate of the luminous keyboard, in which the light guide plate comprises a light guide substrate and a brightness enhancement film;

FIG. 7 is an enlarged fragmentary perspective view illustrating another variant example of the light guide plate of the luminous keyboard, in which the light guide plate comprises a light guide substrate and two brightness enhancement film; and

FIG. 8 is an enlarged fragmentary perspective view illustrating a further variant example of the light guide plate of the luminous keyboard, in which the light guide plate comprises a light guide substrate and two brightness enhancement film.

### DETAILED DESCRIPTION OF THE PREFERRED EMBODIMENT

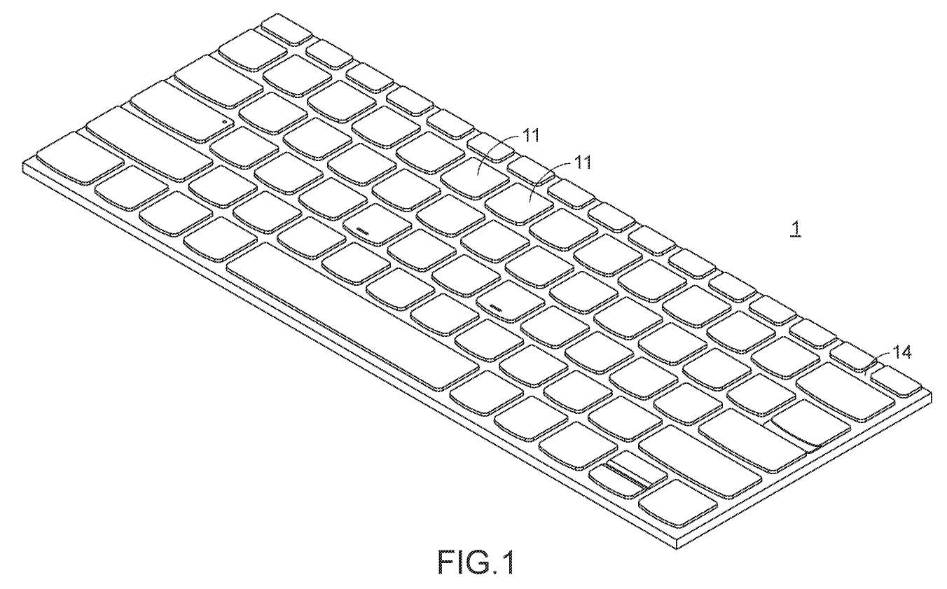

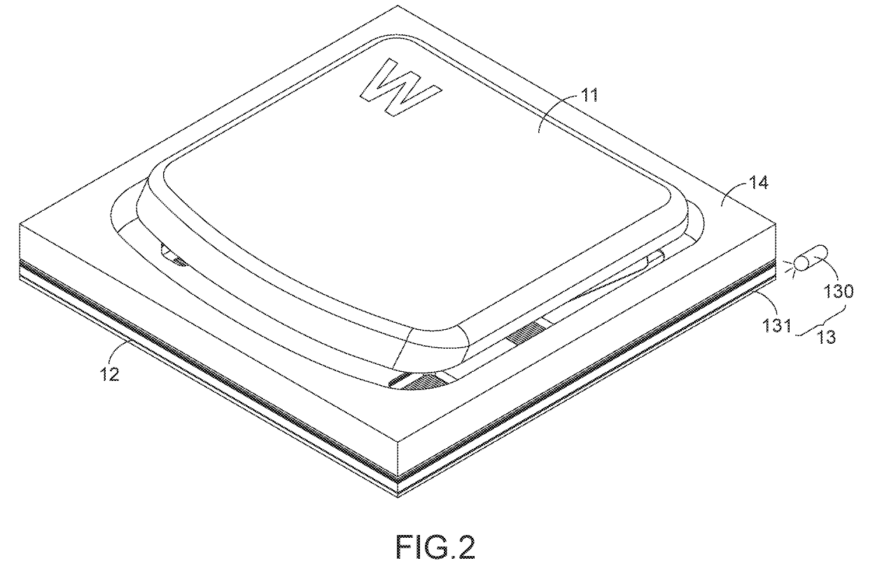

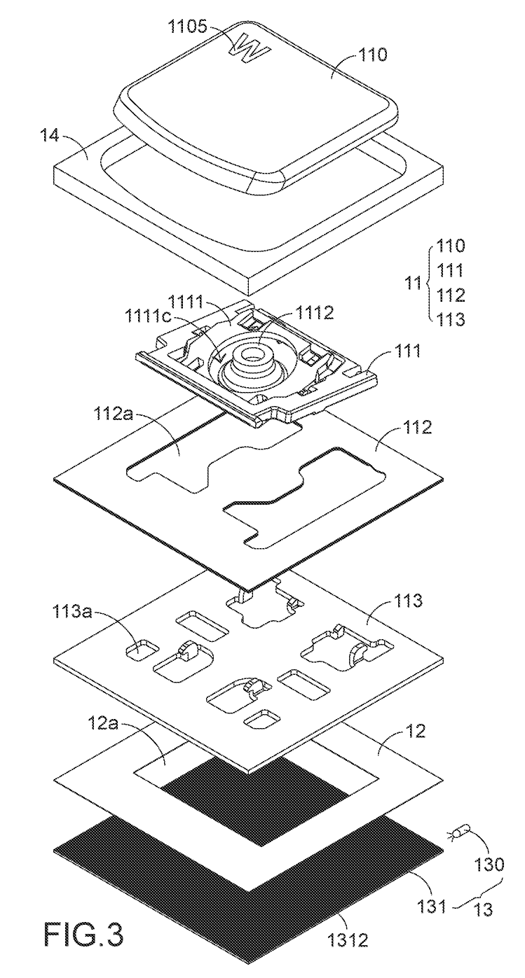

FIG. 1 is a schematic perspective view illustrating the appearance of a luminous keyboard according to an embodiment of the present invention. FIG. 2 is a schematic perspective view illustrating a single key structure of the luminous keyboard according to the embodiment of the present invention. FIG. 3 is a schematic exploded view illustrating the single key structure of the luminous keyboard according to the embodiment of the present invention. As shown in FIGS. 1, 2 and 3, the luminous keyboard 1 comprises plural key structures 11, a shielding plate 12, a light guide module 13 and a frame body 14. The light guide module 13 is sheltered by the frame body 14, and the plural key structures 11 are exposed to the outside through the frame body 14.

Please refer to FIGS. 2 and 3 again. The light guide module 13 emits light beams. The light beams pass through an opening 12a of the shielding plate 12, and the light beams are guided upwardly to pass through the key structure 11. The components of the key structure 11 will be described later. The light guide module 13 is the source of emitting the light beams. In an embodiment, the light guide module 13 comprises a light source 130 and a light guide plate 131. The light source 130 emits the light beams to the light guide plate 131. After the light beams 130 are guided by the light guide plate 131 to travel within the light guide plate 131 for a specified distance, the light beams leave the light guide plate 131 and travel in the direction toward the key structure 11. A keycap 110 of the key structure 11 has at least one light-transmissible zone 1105. The light-transmissible zone 1105 is made of a light-transmissible material. The light beams pass through the light-transmissible zone 1105 to illuminate the luminous keyboard 1.

For well guiding the light beams to the key structure 11, the shielding plate 12 is arranged between a supporting plate 113 of the key structure 11 and the light guide plate 131. Consequently, the light beams are guided to be travel upwardly to the key structure 11. After the light beams pass through the keycap 110, the key structure 11 is illuminated. In more detail, the light-outputting position of the light guide plate 131 is determined according to the position of the opening 12a of the shielding plate 12. The opening 12a of the shielding plate 12 is aligned with the keycap 110. That is, the opening 12a of the shielding plate 12 is disposed under the keycap 110. After the light beams pass through the opening 12a, the light beams travel to the keycap 110. Moreover, a vacant space between every two adjacent key structures 11 is sheltered by the shielding plate 12. Consequently, portions of the light beams that travel to the vacant space are reflected back to the light guide plate 131 by the shielding plate 12. Since the light beams are shaded and reflected by the shielding plate 12, the light beams do not leak to the outside through the vacant space.

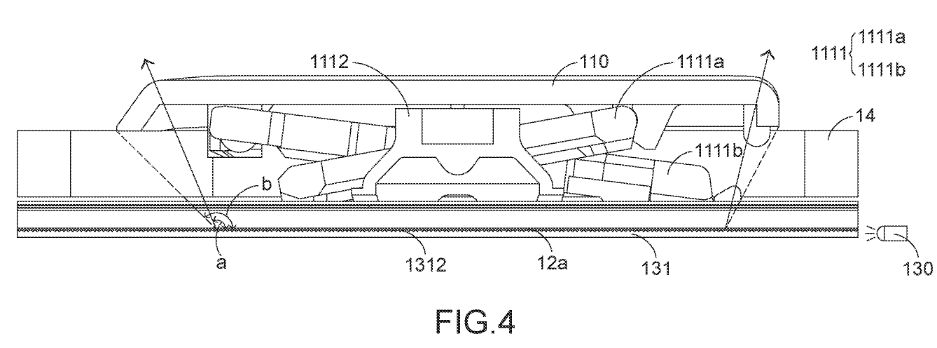

FIG. 4 is a schematic cross-sectional view illustrating the single key structure of the luminous keyboard according to the embodiment of the present invention. Please refer to the FIGS. 3 and 4. As mentioned above, the opening 12a of the shielding plate 12 is disposed under the keycap 110. In addition, the area of the opening 12a of the shielding plate 12 is smaller than the area of the keycap 110. From a top view of the keycap 110, the light beams passing through the opening 12a are shaded by the cross section 110 of the keycap 110. This is the basic structure of the luminous keyboard for avoiding light leakage from the rims of the key structures. Moreover, due to the physical properties of the light guide plate 131 and the light beams, the light-outputting directions of the light beams from the light guide plate 131 are not completely perpendicular to the surface of the light guide plate 131. That is, when the light beams leave the light guide plate 131, the light beams deflect at a beam deflection angle. If the beam deflection angle is too large, the light leakage problem possibly occurs. For solving the light leakage problem, the light guide plate 131 is specially designed. In an embodiment, plural elongated condenser structures 1312 are formed on a top surface of the light guide plate 131. The plural elongated condenser structures 1312 are contiguously arranged side by side. Preferably, the plural elongated condenser structures 1312 are arranged side by side and in parallel with each other. After the light beams travelling within these light guide plate 131 pass through the elongated condenser structures 1312, these light beams are converged. Since the beam angles of these light beams are corrected, the light-outputting directions of the light beams are nearly perpendicular to the surface of the light guide plate 131. That is, the light-outputting directions of the light beams are nearly in parallel with a normal direction of the light guide plate 131. Since the light-outputting position of the light guide plate 131 is determined according to the position of the opening 12a of the shielding plate 12, the light beams outputted from the light guide plate 131 are only permitted to travel upwardly through the opening 12a. The beam angle “a” of the light beams passing through the opening 12a is smaller than the included angle “b” between a line passing through the rim of the opening 12a and the rim of the keycap 110 and the shielding plate 12. Since the optical paths of the light beams are not beyond the line passing through the rim of the opening 12a and the rim of the keycap 110, the light-outputting directions of the light beams are limited. Consequently, the light leakage from the rim of the key structure is avoided.

FIG. 5 is an enlarged fragmentary perspective view illustrating the light guide plate of the luminous keyboard according to the embodiment of the present invention. Each elongated condenser structure 1312 has a semi-cylindrical shape. Moreover, each elongated condenser structure 1312 has a long axial direction P. In a coordinate system, the long axial direction P is in parallel with a Y axial direction. Moreover, the plural elongated condenser structures 1312 are arranged in parallel with each other along an X axial direction of the coordinate system, which is perpendicular to the long axial direction P. In an embodiment, the elongated condenser structures 1312 are V-cut structures, formed on a top surface 1311 of the light guide plate 131, and arranged in parallel with each other along the X axial direction. From a side view, the plural elongated condenser structures 1312 are contiguously arranged side by side to collaboratively form a wavy profile. Preferably, the top surface 1311 of the light guide plate 131 is a smooth surface. Consequently, the efficacy of reducing the scattered light and the efficacy of condensing the light are enhanced.

Hereinafter, the key structure 11 will be illustrated. Please refer to FIGS. 3 and 4 again. Each key structure 11 comprises the keycap 110, a movable triggering mechanism 111, a membrane circuit board 112 and a supporting plate 113. The movable triggering mechanism 111 is disposed under the keycap 110. The membrane circuit board 112 is disposed under the movable triggering mechanism 111. That is, two opposite ends of the movable triggering mechanism 111 are connected with the keycap 110 and the membrane circuit board 112, respectively. When an external pressing force exerted on the keycap 110 is received by the movable triggering mechanism 111, the membrane circuit board 112 is triggered by the movable triggering mechanism 111.

The supporting plate 113 is disposed under the membrane circuit board 112. The movable triggering mechanism 111 is penetrated through the membrane circuit board 112, and movably coupled with the supporting plate 113. The movable triggering mechanism 111 comprises a scissors-type connecting element 1111 and a rubbery elastomer 1112. The movable triggering mechanism 111 comprises a first end 1111a and a second end 1111b, which are opposed to each other. The first end 1111a is connected with the keycap 110. The second end 1111b is penetrated through plural through-holes 112a of the membrane circuit board 112 and connected with the supporting plate 113. The movable triggering mechanism 111 has an accommodation space 1111c. The rubbery elastomer 1112 is disposed within the accommodation space 1111c. An end of the rubbery elastomer 1112 is contacted with the membrane circuit board 112 and disposed on the membrane circuit board 112. When an external pressing force is exerted on the keycap 110, the scissors-type connecting element 1111 and the rubbery elastomer 1112 are pushed by the keycap 110. Consequently, the membrane circuit board 112 is triggered by the rubbery elastomer 1112.

The supporting plate 113 has plural perforations 113a along the optical paths of the light beams. At least portions of the perforations 113a are aligned with the corresponding through-hole 112a. After the light beams leave the elongated condenser structures 1312, the light beams pass through the openings 12a of the shielding plate 12, the perforations 113a of the supporting plate 113, the through-holes 112a of the membrane circuit board 112 and the scissors-type connecting element 1111 sequentially and travel to the keycap 110.

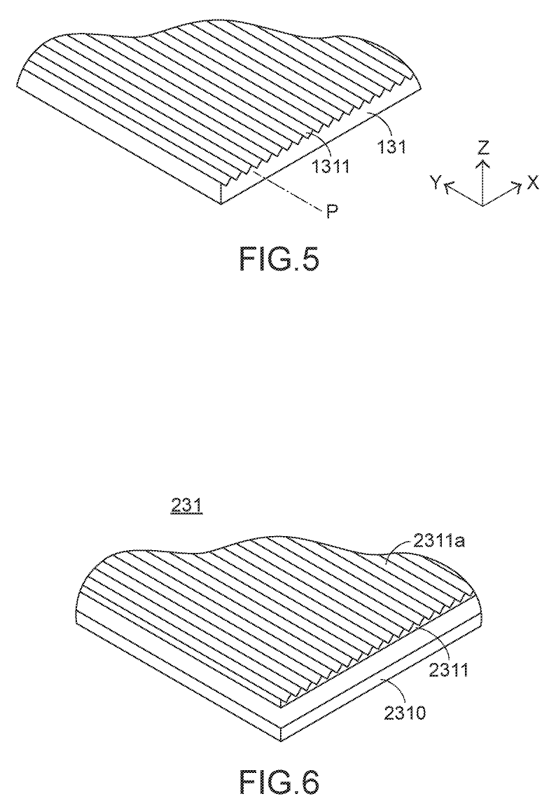

It is noted that numerous modifications and alterations may be made while retaining the teachings of the invention. Some examples of the light guide plate 131 will be illustrated with reference to FIGS. 6, 7 and 8.

FIG. 6 is an enlarged fragmentary perspective view illustrating a variant example of the light guide plate of the luminous keyboard, in which the light guide plate comprises a light guide substrate and a brightness enhancement film. As shown in FIG. 6, the light guide plate 231 comprises a light guide substrate 2310 and a brightness enhancement film 2311. Moreover, plural elongated condenser structures 2311a are formed on the brightness enhancement film 2311. The brightness enhancement film 2311 is stacked over the light guide substrate 2310. Similarly, the light guide plate 231 of FIG. 6 also has the light-condensing function.

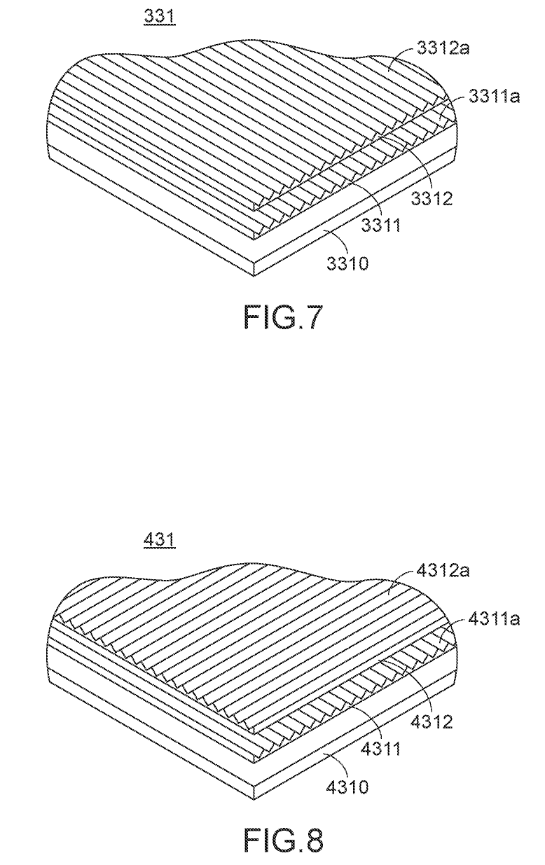

FIG. 7 is an enlarged fragmentary perspective view illustrating another variant example of the light guide plate of the luminous keyboard, in which the light guide plate comprises a light guide substrate and two brightness enhancement film. As shown in FIG. 7, the light guide plate 331 comprises a light guide substrate 3310, a first brightness enhancement film 3311 and a second brightness enhancement film 3312. The first brightness enhancement film 3311 and the second brightness enhancement film 3312 are stacked over the light guide substrate 3310. Moreover, plural first elongated condenser structures 3311a are formed on the first brightness enhancement film 3311, and plural second elongated condenser structures 3312a are formed on the second brightness enhancement film 3312. The arranging direction of the plural first elongated condenser structures 3311a and the arranging direction of the plural second elongated condenser structures 3312a are identical. That is, the plural first elongated condenser structures 3311a and the plural second elongated condenser structures 3312a are in parallel with each other. Since the light guide plate 331 of FIG. 7 comprises first brightness enhancement film 3311 and the second brightness enhancement film 3312 to condense the light beams twice, the light-condensing efficacy is further enhanced.

FIG. 8 is an enlarged fragmentary perspective view illustrating a further variant example of the light guide plate of the luminous keyboard, in which the light guide plate comprises a light guide substrate and two brightness enhancement film. As shown in FIG. 8, the light guide plate 431 comprises a light guide substrate 4310, a first brightness enhancement film 4311 and a second brightness enhancement film 4312. The first brightness enhancement film 4311 and the second brightness enhancement film 4312 are stacked over the light guide substrate 4310. Moreover, plural first elongated condenser structures 4311a are formed on the first brightness enhancement film 4311, and plural second elongated condenser structures 4312a are formed on the second brightness enhancement film 4312. There is an included angle between the arranging direction of the plural first elongated condenser structures 4311a and the arranging direction of the plural second elongated condenser structures 4312a. Preferably, the plural first elongated condenser structures 4311a and the plural second elongated condenser structures 4312a are perpendicular to each other. Since the light guide plate 431 of FIG. 8 comprises first brightness enhancement film 4311 and the second brightness enhancement film 4312 to condense the light beams twice, the light-condensing efficacy is further enhanced.

From the above descriptions, the present invention provides the luminous keyboard. The plural elongated condenser structures are formed on the top surface of the light guide plate and contiguously arranged side by side. By the elongated condenser structures, the beam angles of the light beams from the light guide plate are converged and the light beams are concentrated. Consequently, the brightness of the backlight is increased. Since the light beams do not leak from the vacant spaces between adjacent key structures, the vision line of the user is not interfered. Moreover, since the light beams are outputted from the surfaces of the key structures only, the brightness of the backlight is increased.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A luminous keyboard, comprising:
plural key structures, wherein each of the plural key structures comprises a keycap, a movable triggering mechanism, a membrane circuit board and a supporting plate, wherein the movable triggering mechanism is disposed under the keycap and connected with the keycap, the membrane circuit board is disposed under the movable triggering mechanism, the membrane circuit board is triggered by the movable triggering mechanism when the movable triggering mechanism receives an external pressing force from the keycap, the supporting plate is disposed under the membrane circuit board, and the movable triggering mechanism is penetrated through the membrane circuit board and movably coupled with the supporting plate;
a light guide module disposed under the supporting plate, and comprising a light source and a light guide plate, wherein plural elongated condenser structures are formed on a top surface of the light guide plate, the light source emits plural light beams into the light guide plate, and the plural light beams travel within the light guide plate and pass through the plural elongated condenser structures, wherein each of the plural elongated condenser structures has a long axial direction, and the plural elongated condenser structures are distributed in parallel and along a direction perpendicular to the long axial direction; and
a shielding plate arranged between the supporting plate and the light guide plate, wherein the shielding plate comprises plural openings, and the plural openings are aligned with the corresponding keycaps, wherein a vacant space between every two adjacent key structures is sheltered by the shielding plate,
wherein after the light beams pass through the elongated condenser structures, beam angles of the light beams are converged, wherein first portions of the light beams are reflected back to the light guide plate by the shielding plate, and the first portions of the light beams travel to the plural keycaps through the plural openings, wherein second portions of the light beams are not reflected by the shielding plate, and the second portions of the light beams travel to the plural keycaps through the plural openings, wherein the top surface of the light guide plate is a smooth surface.

2. The luminous keyboard according to claim 1, wherein the elongated condenser structures are V-cut structures, which are formed on the top surface of the light guide plate and arranged in parallel with each other.

3. The luminous keyboard according to claim 1, wherein the movable triggering mechanism comprises a scissors-type connecting element and a rubbery elastomer, and the scissors-type connecting element has a first end and a second end opposed to the first end, wherein the first end of the scissors-type connecting element is connected with the keycap, and the second end of the scissors-type connecting element is penetrated through plural through-holes of the membrane circuit board and connected with the supporting plate, wherein the movable triggering mechanism has an accommodation space, the rubbery elastomer is disposed within the accommodation space, and an end of the rubbery elastomer is contacted with the membrane circuit board.

4. The luminous keyboard according to claim 3, wherein the supporting plate comprises plural perforations, and at least portions of the perforations are aligned with the corresponding through-holes, wherein after the second portions of the light beams leave the elongated condenser structures, the second portions of the light beams pass through the openings of the shielding plate, the perforations of the supporting plate and the through-holes of the membrane circuit board sequentially and travel to the keycaps of the plural key structures.

5. The luminous keyboard according to claim 1, wherein the light guide plate comprises a light guide substrate and a brightness enhancement film, wherein the brightness enhancement film is stacked over the light guide substrate, and the plural elongated condenser structures are formed on the brightness enhancement film.

6. The luminous keyboard according to claim 1, wherein the light guide plate comprises a light guide substrate, a first brightness enhancement film and a second brightness enhancement film, wherein the first brightness enhancement film and the second brightness enhancement film are stacked over the light guide substrate, and the elongated condenser structures include plural first elongated condenser structures and plural second elongated condenser structures, wherein the plural first elongated condenser structures are formed on a top surface of the first brightness enhancement film, and the plural second elongated condenser structures are formed on the second brightness enhancement film.

7. The luminous keyboard according to claim 6, wherein the plural first elongated condenser structures on the first brightness enhancement film are arranged along a first direction and in parallel with each other, and the plural second elongated condenser structures on the second brightness enhancement film are arranged along a second direction and in parallel with each other, wherein the first direction is in parallel with the second direction, or the first direction and the second direction intersect each other.

8. The luminous keyboard according to claim 1, further comprising a fame body, wherein the plural key structures are exposed through the frame body, and the light guide module is sheltered by the frame body.
